(19) United States
(12) Patent Application Publication
(10) Pub. No.: US 2022/0074235 A1
(43) Pub. Date: Mar. 10, 2022

(54) AUTOMATIC DOOR OPENING DEVICE USING THERMAL EXPANSION OF SHAPE MEMORY ALLOY

(71) Applicant: Ryan Joongi Cho, Seoul (KR)

(72) Inventor: Ryan Joongi Cho, Seoul (KR)

(21) Appl. No.: 17/013,552

(22) Filed: Sep. 5, 2020

(51) Int. Cl. E05B 65/10; E05B 51/00

(52) U.S. Cl. CPC E05B 65/104; E05Y 2900/134; E05B 51/005

(57) ABSTRACT

When an emergency situation such as a fire occurs, a rescuee trapped in a room is embarrassed or loses judgment, and thereby a situation of forgetting how to release the locking device, repeating an erroneous operation, or the like occurs. Therefore, when a situation such as a fire occurs, a front door, which is a most effective evacuation path, cannot be used, and thereby in most cases of fire, deaths in front of the door are frequently reported. The present invention is made to improve the above-described problems, and relates to a fire safety door lock of which a lock state is automatically released by automatically operating, as illustrated in the drawing below, a spring composed of a shape memory alloy connected to a locking bar of the digital door lock when being operated, and which is capable of being opened independently without being affected by other circuits.

### TECHNICAL FIELD

The present disclosure relates to an automatic door opening device using thermal expansion of shape memory alloy, and more particularly to an automatic door opening device using thermal expansion of shape memory alloy including a door lock, a safety door, a shape memory alloy, and bimetal.

### BACKGROUND

After the discovery of the titanium-nickel alloy in the early 960s, it was confirmed that more than 20 kinds of alloys have a shape memory effect so far, and among these, well-known and developed shape memory alloys are copper-zinc-aluminum alloy, copper-aluminum-nickel alloy, titanium-nickel alloy, and the like. Because the shape memory alloy generates great force while recovering its shape, it is widely applied in various industrial fields, and can also be used for medical and dental purposes such as artificial muscles.

The shape memory alloy is capable of recovering its shape only by deformation of about 6 to 10%, and if it is deformed beyond that, it hardens as it is, and there are several problems that a temperature region in which this shape memory effect appears is too narrow, and the like. Therefore, a research is in progress to solve the problems, and a research on the development of the shape memory alloy based on new ideas is also in full swing. In addition, new shape memory alloys are being discovered, so that if they are put into practical use, it will be possible to select an appropriate alloy according to the application.

### SUMMARY

Recently, a variety of locking devices are installed on entrance doors such as homes or offices, and electronic locking devices are made of various shapes and structures, and recently, a digital door lock that is easy to use and has excellent protection against theft accidents has been installed. Such a locking device is designed so that the locked state is released from the outside by using a separate key, while the locked state is released indoors by simply pressing a button.

However, when an emergency situation such as a fire occurs, a rescuee trapped in a room is embarrassed or loses judgment, and thereby a situation of forgetting how to release the locking device, repeating an erroneous operation, or the like occurs. Therefore, when a situation such as a fire occurs, a front door, which is a most effective evacuation path, cannot be used, and thereby in most cases of fire, deaths in front of the door are frequently reported.

The present invention relates to a door that is automatically opened in case of a fire by interlocking with a digital door lock that is installed in a door of a home, an office, or the like, and more specifically a door that is automatically opened in a case of a fire by interlocking with a digital door lock, in which the door is automatically opened by automatic release of the digital door lock and an elastic force of a spring according to a temperature change of a shape memory alloy.

### Advantageous Effects

Recently, a variety of locking devices have been installed on the doors of a home, an office, or the like, and the electronic locking device has been made up of various shapes and structures. In addition, recently, the digital door lock has been installed, which is easy to use and has excellent protection measure against theft accidents. Such a locking device is designed so that the locked state is released from the outside by using a separate key, while the locked state is released indoors by simply pressing a button.

### BRIEF DESCRIPTION OF THE DRAWING

FIG. 1 is a view illustrating an automatic door opening device using thermal expansion of shape memory alloy according to an embodiment of the present invention.

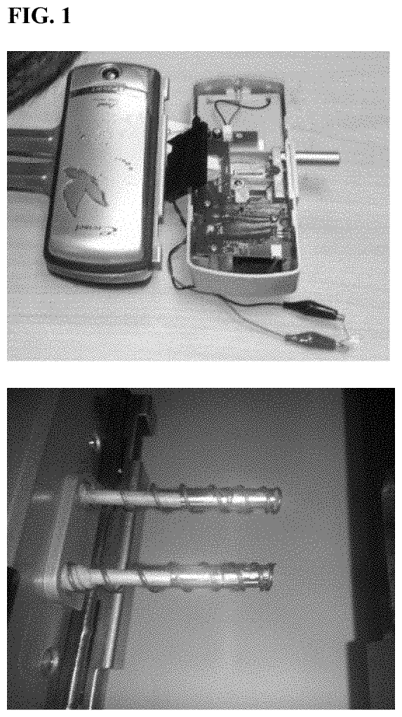

### DETAILED DESCRIPTION OF THE DISCLOSURE

During a detection operation of an existing sensor caused by a fire, an anxiety that the door may not be opened due to a circuit being damaged by heat is eliminated, and a quick response is possible against the fire, as well as a best evacuation passage is secured. In addition, it has an advantage that can creates a door that automatically opens in case of a fire by interlocking with the safety door made of the shape memory alloy, which minimizes personal damage and reduces property damage due to the rapid response measure against the fire by allowing the rescuee to quickly evacuate from an ignition site guide to an instinctive evacuation ability even if the rescuee is embarrassed or loses judgment. When an emergency situation such as a fire occurs, a rescuee trapped in a room is embarrassed or loses judgment, and thereby a situation of forgetting how to release the locking device, repeating an erroneous operation, or the like occurs.

Therefore, when a situation such as a fire occurs, a front door, which is a most effective evacuation path, cannot be used, and thereby in most cases of fire, deaths in front of the door are frequently reported. The present invention is made to improve the above-described problems, and relates to a fire safety door lock of which a lock state is automatically released by automatically operating, as illustrated in the drawing below, a spring composed of a shape memory alloy connected to a locking bar of the digital door lock when being operated, and which is capable of being opened independently without being affected by other circuits.

What is claimed is:

1. An automatic door opening device using thermal expansion of shape memory alloy, comprising a fire safety door lock of which a lock state is automatically released by automatically operating a spring composed of a shape memory alloy connected to a locking bar of the digital door lock when being operated, and which is capable of being opened independently without being affected by other circuits.
